(19) United States
(12) Patent Application Publication
(10) Pub. No.: US 2023/0075077 A1
(43) Pub. Date: Mar. 9, 2023

(54) RISK DETERMINATION IN NAVIGATION

(71) Applicant: KONINKLIJKE PHILIPS N.V., Eindhoven (NL)

(72) Inventors: Bin Yin, Shanghai (CN); Yi Zhou, Shanghai (CN); Meng Zhe Tao, Shanghai (CN); Jing Han, Shanghai (CN)

(21) Appl. No.: 17/938,993

(22) Filed: Sep. 7, 2022

(30) Foreign Application Priority Data
Sep. 7, 2021 (CN) PCT/CN2021/116823

(51) Int. Cl. G01C 21/34; G01C 21/36; G06N 20/00

(52) U.S. Cl. CPC G01C 21/3461; G01C 21/3415; G01C 21/3484; G01C 21/3617; G01C 21/3697; G06N 20/00

(57) ABSTRACT

In an embodiment, a method is described. The method comprises receiving an indication of at least one risk factor associated with at least one geographical area. The method further comprises determining a risk level for a user along at least one candidate navigation route comprising the at least one geographical area. The risk level is determined based on: the at least one risk factor; and at least one characteristic associated with the user.

### TECHNICAL FIELD OF THE INVENTION

The invention relates to a method, non-transitory machine-readable medium and apparatus for determining risk level in navigation.

### BACKGROUND OF THE INVENTION

There are various risk factors in daily living that people may encounter. In some cases, people may not be aware of such risk factors. In some cases, people may be aware of such risk factors but do not know how to circumvent them. Such risk factors may or may not affect the health status of a person. A person with a chronic disease or certain health condition may be at particular risk from certain risk factors. For example, a chronic disease patient may have an adverse health outcome if they are exposed to certain infections.

### SUMMARY OF THE INVENTION

Aspects or embodiments described herein may relate to managing or reducing risks in navigation. Aspects or embodiments described herein may obviate one or more problems associated with navigating in certain geographical areas having certain associated risk factors.

In a first aspect, a method is described. The method is a computer-implemented method. The method comprises receiving an indication of at least one risk factor associated with at least one geographical area. The method further comprises determining a risk level for a user along at least one candidate navigation route comprising the at least one geographical area. The risk level is determined based on the at least one risk factor and at least one characteristic associated with the user.

Some embodiments relating to the first aspect and other aspects are described below.

In some embodiments, the method comprises receiving an indication of a first location and/or a second location. The first location corresponds to a present user location and/or a departure location. The second location corresponds to a destination. The method further comprises identifying the at least one candidate navigation route. The identified at least one candidate navigation route is between the first location and the second location. The method further comprises selecting, from the identified at least one candidate navigation route, a navigation route for the user based on at least one selection rule.

In some embodiments, the method comprises determining whether the risk level for the identified at least one candidate navigation route is within the user's risk tolerance. The user's risk tolerance is determined based on the user's at least one characteristic and/or the user's preference. The method further comprises selecting the navigation route for the user that is with the user's risk tolerance based on the at least one selection rule.

In some embodiments, the method comprises determining whether the risk level for the identified at least one candidate navigation route is within the user's risk tolerance by comparing the risk level for each of the identified at least one candidate navigation route with a risk tolerance metric indicative of the candidate navigation route being within the user's risk tolerance. In response to determining that the risk level for the candidate navigation route is within the user's risk tolerance, the method further comprises identifying the candidate navigation route as being within the user's risk tolerance. In response to determining that the risk level for the candidate navigation route is not within the user's risk tolerance, the method further comprises indicating that the candidate navigation route is risky for the user.

In some embodiments, the at least one selection rule specifies that the identified at least one candidate navigation route with the lowest risk level is to be selected for the user.

In some embodiments, the identified at least one candidate navigation route that has a risk level within the user's risk tolerance is to be selected. The user's risk tolerance is determined based on the user's at least one characteristic and/or the user's preference. If there is a plurality of identified candidate navigation routes each having a risk level within the user's risk tolerance, one of the plurality of identified candidate navigation routes is to be selected based on: which of the plurality of identified candidate navigation routes has the lowest travel time and/or distance; availability of transport options for each of the plurality of identified candidate navigation routes; and/or the user's preference.

In some embodiments, if none of the identified at least one candidate navigation route have a risk level within the user's risk tolerance, the user's risk tolerance is determined based on the user's at least one characteristic and/or the user's preference. In some embodiments, the method further comprises providing an indication that the identified at least one candidate navigation route is not within the user's risk tolerance. In some embodiments, the method further comprises selecting the navigation route for the user based on the at least one selection rule. In some embodiments, the at least one selection rule specifies that the identified at least one candidate navigation route with the lowest risk level is to be selected for the user. In some embodiments, the at least one selection rule specifies that the identified at least one candidate navigation route is to be selected based on: which of the identified at least one candidate navigation route has the lowest travel time and/or distance; availability of transport options for the identified at least one candidate navigation route; and/or the user's preference.

In some embodiments, the method comprises causing a graphical user interface to display the identified at least one candidate navigation route alongside an indication of the risk level for each of the displayed candidate navigation routes. The method further comprises receiving a user input indicative of the user's preference. The method further comprises selecting the navigation route for the user according to the user input.

In some embodiments, the method comprises generating navigation data corresponding to the selected navigation route.

In some embodiments, the method comprises causing a navigation application on a user device to load the generated navigation data for use in providing navigation instructions for the user.

In some embodiments, the user's at least one characteristic comprises information regarding at least one medical condition and/or demographic information associated with the user.

In some embodiments, the risk level for the at least one candidate navigation route is calculated using at least one risk model configured to estimate the risk level for the user along the at least one candidate navigation route. The risk model is trained using a training data set indicative of at least one correlation between a plurality of risk factors and a plurality of characteristics.

In some embodiments, the at least one risk model is configured to estimate the risk level for the user along a plurality of sub-routes of the at least one candidate navigation route. The risk level calculated for the at least one candidate navigation route is based on a weighted combination of the estimated risk level associated with each of the plurality of sub-routes.

In some embodiments, the at least one risk factor comprises an environmental risk and/or presence of at least one infectious agent within the at least one geographical area.

In a second aspect, a non-transitory machine readable medium is described. The non-transitory machine-readable medium stores instructions readable and executable by at least one processor to cause the at least one processor to implement the method of any of the first aspect or related embodiments.

In a third aspect, apparatus is described. The apparatus comprises at least one processor communicatively coupled to an interface for receiving an indication of at least one risk factor associated with at least one geographical area. The apparatus further comprises a non-transitory machine-readable medium storing instructions readable and executable by the at least one processor. The instructions cause the at least one processor to determine a risk level for a user along at least one candidate navigation route comprising the at least one geographical area. The risk level is determined based on the at least one risk factor and at least one characteristic associated with the user.

Aspects or embodiments described herein may have at least one of the following technical benefits. Certain embodiments may determine risk levels for a user based on at least one characteristic associated with the user. The user may be provided with guidance on which navigation route is suitable for them based on the determined risk levels and/or they may be able to make an informed decision based on the determined risk level. Certain embodiments may help to reduce the likelihood of the health status of a user being adversely affected by certain risks which they may encounter when travelling, for example, by redirecting the user via a suitable navigation route e.g., within their risk tolerance. Certain embodiments may provide a fine level of detail (e.g., by street level) regarding the navigation route to take to minimize risks to the user. For example, even if a certain geographical area is risky for the user, the navigation route selected for the user may minimize risks e.g., by recommending a navigation route such that they may avoid streets, certain locations, etc. associated with certain risks or higher risk areas.

These and other aspects of the invention will be apparent from and elucidated with reference to the embodiment(s) described hereinafter.

### BRIEF DESCRIPTION OF DRAWINGS

Exemplary embodiments of the invention will now be described, by way of example only, with reference to the following drawings, in which:

FIG. 1 refers to a method of determining risk level in navigation according to an embodiment;

FIG. 2 is a schematic drawing of an example system for implementing certain embodiments;

FIG. 3 is a schematic drawing of an example architecture for implementing certain embodiments;

FIG. 4 refers to a method of selecting a navigation route according to an embodiment;

FIG. 5 refers to a method of determining whether a risk level is within a user's risk tolerance according to an embodiment;

FIG. 6 refers to a method of selecting a navigation route according to user input according to an embodiment;

FIG. 7 refers to a method of generating and using navigation data according to an embodiment;

FIG. 8 is a schematic drawing of a machine-readable medium for determining risk level in navigation according to an embodiment; and

FIG. 9 is a schematic drawing of apparatus for determining risk level in navigation according to an embodiment.

### DETAILED DESCRIPTION OF THE EMBODIMENTS

A person may encounter various risks when travelling to a destination. Such risks may or may not be a concern for the person. For example, a person without any underlying health conditions may not have any concerns about travelling to or via a geographical area associated with a certain risk such as infection risk or other risks such as arising from environment conditions in the geographical area. However, a person with an underlying health condition may have concerns about travelling to or via a geographical area associated with a certain risk such as infection risk (i.e., where such an infection risk might adversely affect the health status of the person). Other factors may affect whether or not a person is at risk when travelling to or via a geographical area associated with a certain risk. For example, the demographic status (e.g., age, sex, ethnicity and/or other characteristic) of the person may affect whether or not the person is at risk.

Although a person may be able to manage the risks the person is exposed to when travelling e.g., by monitoring the news for updates, there may be scenarios where a person may not have sufficient information, knowledge or time to be able to make a decision on how best to manage or reduce risk.

Certain embodiments of this disclosure may be used for managing risk for a person (i.e., a ‘user’) by identifying at least one navigation route that may take into account at least one risk factor for the person.

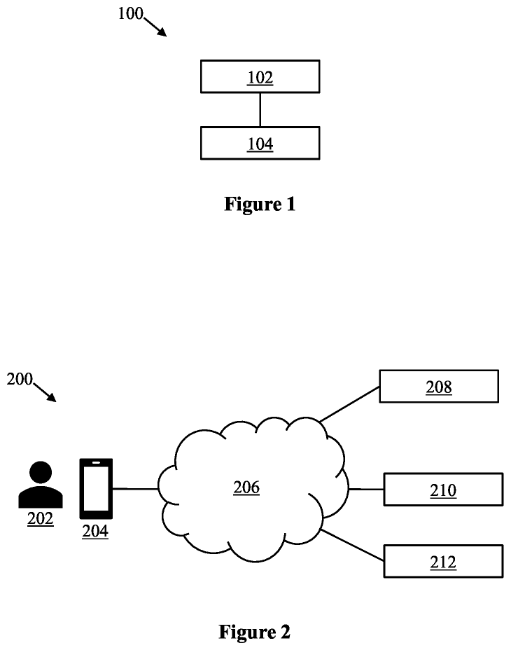

FIG. 1 refers to a method 100 of determining risk level in navigation according to an embodiment. The method 100 is a computer-implemented method, which may be implemented by processing circuitry. As described in more detail below, the method 100 may be implemented by a user device and/or a remote service such as provided in the cloud or provided by a server.

The method 100 comprises, at block 102, receiving an indication of at least one risk factor associated with at least one geographical area.

In some embodiments, the at least one risk factor comprises an environmental risk and/or presence of at least one infectious agent within the at least one geographical area.

Examples of environmental risks include: poor air quality (e.g., pollution such as particulate matter, ozone and/or nitrogen oxides), humidity (e.g., high or low humidity levels may be a risk to certain users), temperature (e.g., high or low temperatures may be a risk to certain users), allergen levels, noise level (e.g., excessive noise levels may exacerbate certain health conditions), chemical hazards, radiation hazards (e.g., ionizing radiation and/or non-ionizing radiation), hazards arising from natural phenomena (e.g., smoke from bush fire, volcanic material such as ash, flooding, etc.), certain weather events (e.g., storms, etc.), and so on.

Examples of infectious agents include viruses, bacteria, fungi and/or parasites.

The indication of the at least one risk factor may be in any suitable format for being interpreted by the processing circuitry so that the method 100 can be implemented. For example, the indication may comprise a risk identifier (e.g., a code representative of the risk factor) and/or risk description (e.g., plaintext description of the risk), risk probability (e.g., likelihood of being affected by the risk) and/or location information (e.g., co-ordinates) indicative of the geographical area associated with the identified risk. The indication may be generated by a risk identification service, such as described below.

The indication may provide information at an appropriate level of granularity. For example, the geographical area may be at a level appropriate for the risk, e.g., by street, by town, by city, by a region in a country, by country, by continent, etc. The risk factor(s) associated with the geographical area may be at any level of granularity. For example, the risk factor(s) may be the same for the whole geographical area or may vary for different locations/areas within the geographical area.

The indication of the at least one risk factor may comprise any relevant risk factors. For example, if the user is near to the at least one geographical location and/or planning a journey to or via the at least one geographical location, the indication received may be appropriate for the user's needs.

The method 100 further comprises, at block 104, determining a risk level for a user along at least one candidate navigation route comprising the at least one geographical area. The risk level is determined based on (i) the at least one risk factor; and (ii) at least one characteristic associated with the user.

A candidate navigation route may refer to a potential travel route (which may be represented by ‘directions’ (e.g., at street level) or other instructions indicative of the route to be taken) between a first location and a second location. For example, there may be one or multiple possible navigation routes between the first and second locations. Each candidate navigation route may or may not be associated with some degree of risk (i.e., the risk factors may vary per candidate navigation route).

A characteristic associated with the user may refer to a medical condition (e.g., high/low blood pressure, high/low blood glucose, dyslipidemia, chronic disease, compromised immune system, etc.), user information relating to demographic and/or health status (e.g., age, sex, ethnicity, body-mass index (BMI), general health (e.g., healthy or not healthy), minor illness (e.g., cold, cough, flu), etc.), etc. The at least one characteristic associated with the user may be correlated with at least one risk factor such that a health status of the user may be at greater risk from the risk factor due to their characteristic. In other similar words, a certain characteristic may be correlated with a certain risk factor such that users with such a characteristic may be at risk (rather than other users not having such a characteristic) when exposed to the risk factor. An example may be a user with a characteristic such as a compromised immune system and a risk factor such as a pandemic (e.g., COVID-19). In this situation, the user may wish to avoid any geographical areas associated with this risk factor when travelling.

Where at least one candidate navigation route has been identified (as discussed in more detail below), the risk level for the at least one candidate navigation route may be determined to take into account both the at least one risk factor and the at least one characteristic associated with the user.

The information provided by the method 100 (i.e., the determined risk level) may be used to inform a decision or a recommendation on whether a candidate navigation route is appropriate for the user based on their at least one characteristic. Certain embodiments described here may use the risk level determined by the method 100 to inform a decision and/or make a recommendation for the user (e.g., identify possible navigation routes for the user, select a navigation route for the user, highlight risks, etc.) that may reduce risks to the user's health status.

Certain embodiments may determine risk levels for a user based on at least one characteristic associated with the user. The user may be provided with guidance on which navigation route is suitable for them based on the determined risk levels and/or they may be able to make an informed decision based on the determined risk level. Certain embodiments may help to reduce the likelihood of the health status of a user being adversely affected by certain risks which they may encounter when travelling, for example, by redirecting the user via a suitable navigation route e.g., within their risk tolerance. Certain embodiments may provide a fine level of detail (e.g., by street level) regarding the navigation route to take to minimize risks to the user. For example, even if a certain geographical area is risky for the user, the navigation route selected for the user may minimize risks e.g., by recommending a navigation route such that they may avoid streets, certain locations, etc. associated with certain risks or higher risk areas.

FIG. 2 is a schematic drawing of an example system 200 for implementing certain embodiments described herein (e.g., the method 100 and certain other embodiments). In the example system 200, a user 202 has a device 204 (e.g., a computing device such as a mobile phone, tablet, Internet-of-Things (IoT) device, etc.) for helping the user 202 to manage or reduce risks. The device 204 is communicatively coupled to cloud 206 for providing certain services (e.g., data routing, processing, etc.) and/or connecting entities in the system 200. In this example system 200, a risk identification service 208, a navigation service 210 and a risk model 212 are provided and are communicatively coupled to the cloud 206.

The risk identification service 208 may receive information from other sources (not shown) such as news sources, authorities (e.g., government agencies, etc.) and/or other sources of available data relating to potential environmental risks and/or presence of infectious agents in the at least one geographical area.

The navigation service 210 may generate navigation data (e.g., directions or other instructions) for the user 202 based on the user's 202 present location/departure location (i.e., a ‘first location’) and the user's 202 destination (i.e., a ‘second location’). The navigation service 210 may receive information such as the user's 202 position (e.g., using location data derived by accessing a Global Navigation Satellite System (GNSS) such as the Global Positioning System (GPS)) and/or an indication of the first and/or second location. The navigation service 210 may have access to mapping data for identifying at least one candidate navigation route between the first location and the second location. In accordance with certain embodiments described herein, the navigation service 210 may take into account the risk level for the candidate navigation route and/or the user's 202 preference when identifying and/or selecting a navigation route for the user 202.

Processing circuitry (not shown but could be implemented in the cloud 206, a server or the user device 204) for implementing the risk model 212 may determine the risk level based on (i) the at least one risk factor; and (ii) the at least one characteristic associated with the user 202. For example, the processing circuitry may receive an indication of the at least one risk factor from the risk identification service 208 and also receive the at least one characteristic associated with the user 202 (e.g., the characteristic may be input by the user, a health worker, and/or may be determined from the user's 202 medical records). In response to receiving such information, the processing circuitry may determine the risk level for the candidate navigation route by implementing the risk model 212. As explained in more detail below, in some cases, the risk model 212 may be trained using a training data set (e.g., in the case of machine learning) or may implement another type of (e.g., non-machine learning) model.

Certain methods described herein may be implemented at any appropriate location in the example system 200.

For example, in one scenario, the determining of the risk level according to the method 100 (and according to certain other embodiments described herein) may be implemented by a remote service (e.g., in the cloud 206, on a server, etc.). The remote service may have access to the data (e.g., by receiving such data and/or having access to a memory storing such data) needed to implement the method 100.

In another scenario, the determining of the risk level according to the method 100 (and according to certain other embodiments described herein) may be implemented by the user device 204. Similarly, the user device 204 may have access to the data (e.g., by receiving such data and/or having access to a memory storing such data) needed to implement the method 100.

Thus, the method 100 (and certain other embodiments described herein) may be implemented by any appropriate entity in the system 200 with processing circuitry, providing such processing circuitry has access to or can receive the data needed for implementing the method 100.

In addition, the architecture of the system 200 may vary. For example, a server may provide data processing services (e.g., for a remote service such as described above) instead of the cloud 206. In another example, any of the risk identification service 208, navigation service 210 and/or risk model 212 may be deployed in the cloud 206/at a server and/or on the user device 204 itself. Any type of data communication technique may be used for providing data exchange (e.g., a radio access network (e.g., for cellular communication) may be used to send data such as indications of risk factors to the user device 204 so that the user device 204 can take action such as determining the risk level and/or requesting a remote service to determine the risk level).

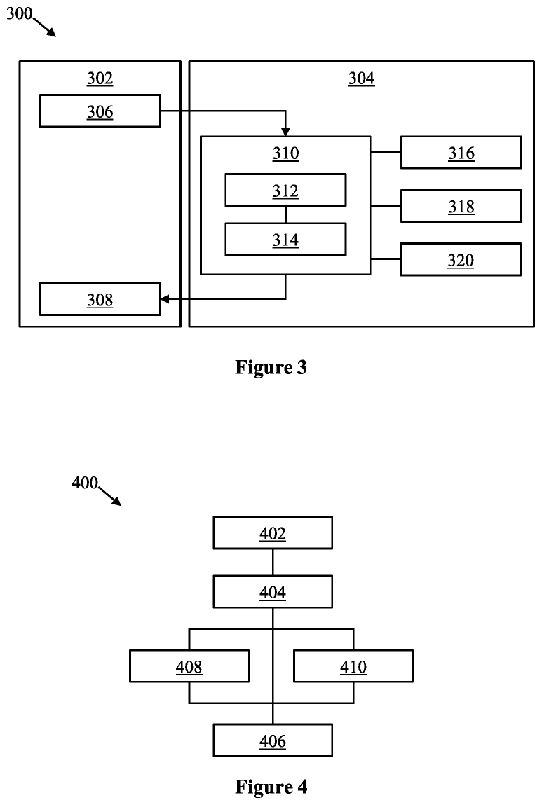

FIG. 3 is a schematic drawing of an example architecture 300 for implementing certain embodiments described herein. Reference is made to the features described in relation to FIG. 2.

The architecture 300 comprises a (user-facing) frontend 302 for obtaining certain data and providing a user with information (e.g., risk level, proposed navigation routes, etc.) relating to the obtained data and/or other data obtained elsewhere. The architecture 300 further comprises a backend 304 for determining the information from the obtained data and obtaining other data that may be relevant for determining the information for the user.

The frontend 302 comprises a data obtaining block 306. With reference to FIG. 2, the data obtaining block 306 may be implemented by the user device 204. In some cases the data obtaining block 306 may connect with the risk identification service 208 and/or navigation service 210 to obtain data therefrom.

In a first category of obtained data, the data obtaining block 306 may obtain travel information such as the user's present location, departure location, destination and/or travel options (e.g., walking, bicycle, car, public transport, etc.). Such travel information may be obtained by user input (e.g., departure location/destination) and/or by accessing data held by other entities such as the navigation service 210.

In a second category of obtained data, the data obtaining block 306 may obtain user 202 information such as at least one characteristic (e.g., medical condition, demographic information and/or health status). Such characteristic information may be obtained by user input (e.g., as prompted by a user interface of the user device 204) and/or by accessing data held by other entities such as medical records (not shown).

In a third category of obtained data, the data obtaining block 306 may obtain information regarding at least one environmental risk. Such environmental risk information may be obtained by from the risk identification service 208.

In a fourth category of obtained data, the data obtaining block 306 may obtain information regarding at least one infectious agent. The information regarding the infectious agent may indicate the level of risk associated with the infectious agent, the prevalence of the infectious agent (e.g., number/density of people affected by the infectious agent), reproduction factor (e.g., the ‘R0’ number), etc.

Any number or combination of the first to fourth categories of data may be obtained.

The frontend 302 further comprises a user interface 308 (e.g., associated with the user device 204). The user interface 308 may be used for receiving user input (e.g., for the data obtaining block 306), displaying a navigation route and/or providing instructions and/or recommendations for a user. Thus, the user interface 308 may provide a user with information relating to the obtained data and/or other data source, which may help the user to manage or reduce risks determined from the obtained data and/or other data source.

In FIG. 3, the backend 304 implements certain embodiments described herein (e.g., method 100) although in other cases, at least part of the frontend 302 may implement or facilitate the implementation of certain embodiments described herein.

The backend 304 comprises processing circuitry 310 for implementing the risk model 212. A risk determination block 312 of the processing circuitry 310 receives information for determining the risk (e.g., the obtained data from the frontend 302 and/or other sources of data) and determines the risk level associated with at least one candidate navigation route (e.g., in accordance with the method 100). A navigation route identification block 314 of the processing circuitry 310 identifies at least one candidate navigation route from the obtained information (e.g., the first and second locations). The other sources of data, accessible to the backend 304, comprise an infectious agent data source 316, an environment risk data source 318 and an auxiliary data source 320 (for any other data). In some cases, such data sources 316, 318, 320 may be provided by the risk identification service 208 of FIG. 2.

Thus, the navigation route identification block 314 may identify the at least one candidate navigation route and the risk determination block 312 may determine the risk level for the at least one candidate navigation route. In some cases, the risk level determination and the candidate navigation route identification may be implemented separately, as shown by FIG. 3. In other cases, the risk level determination may be implemented in conjunction with the candidate navigation route identification (i.e., the identification/selection of the candidate navigation route may take into account the risk level during identification). Upon identification/selection of the navigation route for the user, navigation data corresponding to the navigation route may be generated and sent to the frontend 302 so that the user interface 308 can provide directions and/or instructions for the user.

An example implementation of the architecture 300 is now described.

The frontend 302 may be implemented by an application installed on a user device 204 such as a personal mobile phone or tablet. The frontend 302 may have a user-facing graphical user interface (GUI), which is communicatively coupled to the backend 304 (which may receive the obtained data and/or data from other sources and perform data processing for implementing certain embodiments described herein).

With functionality similar to a GNSS navigating application, the GUI may display navigation data for the user e.g., to indicate the departure and destination information, the transport options (e.g., car, public transportation, or on foot, etc.), at least one identified/selected route for the user and the real-time position of the user. In accordance with certain embodiments described herein, the identified/selected route may take into account at least one characteristic associated with the user so that the risk level associated with the navigation route is within the user's risk tolerance.

The processing circuitry 310 calculates the navigation route based on the departure location (and/or present location), destination and any other auxiliary information the user has provided (e.g., ‘user input’), a map of the region, and real-time data with regard to environmental risks and/or infectious agents in the geographical area and/or neighboring geographical areas. Such data may be acquired from publicly available data sources e.g., using wireless and/or cloud technologies. The processing circuitry 310 may identify and select a navigation route that is associated with a minimized or reduced level of risk for the user 202. When connecting to the GNSS (e.g., GPS), the real-time position of the user 202 can be extracted and overlaid on the proposed navigation route.

In the example implementation, the frontend 302 may obtain, via the user interface 308, information input by the user so that the backend 304 can determine the risk level associated with at least one candidate navigation route and provide navigation data for the user interface 308 to display. In another example implementation, certain information may be input from another data source (e.g., medical records) accessible to the frontend 302 and/or backend 304.

Thus, in some cases, the user 202 may input, via the user interface 308, at least one characteristic (e.g., medical condition(s), health status, demographic information, etc.), define the departure location (unless indicated by the present location via the GNSS) and destination, select a transport portion (e.g., car, public transport, foot, etc.), and select any risk factors relevant to the region of travel and of a personal concern (e.g., environmental risks and/or infectious agents that are concerning for the user). In some cases, the frontend 302 may be able to provide a list of candidate risk factors (e.g., alongside an indication of a degree of relevance of the risk factor) for the user to choose from. For example, the frontend 302 may present possible risk factors that may be relevant to the user if there is information (e.g., at least one characteristic) available about the user that the risk model 212 (e.g., implemented by the processing circuitry 310) can use to identify certain risk factors which could be relevant to the user and the user may select at least one of these risk factors (or the user may not need to make any selection).

The user interface 308 may further display any identified (candidate) navigation routes with risk levels indicated (e.g., using color coding of each of the displayed navigation routes such as red=high risk, orange=medium risk and green=low risk). In some cases, the risk level may be personalized to the user 202 (since the risk level may be determined based on the user's 202 at least one characteristic). In some cases, multiple navigation routes may be shown. In some cases, each navigation route shown may have different risk factors but overall, there may be no or little difference in risk to the user 202 if taking any of these navigation routes. In some cases, the user interface 308 may display further factors that may be relevant to the user 202 (e.g., estimated travel time, traffic levels, transport options, etc.). The user 202 may be able to select one of the proposed navigation routes based on their preference and/or may be able to select a different navigation route if the recommended navigation route is not suitable (e.g., due to the estimated travel time, traffic levels, transport options, etc.). In this regard, by displaying the different risk levels associated with each available navigation route, the user may be able to make an informed decision about which navigation route to use.

The backend 304 may be configured to obtain data remotely from available (e.g., public) data sources, e.g., a regional center for disease control (CDC) for latest information on infectious agents and/or a meteorological or environmental division of the government for environmental and weather information.

The processing circuitry 310 may estimate or stratify the risk level for each possible navigation route based on the risk model 212 (according to any risk factors input to the risk model 212), and may recommend or select at least one navigation route for the user 202, which may be prioritized according to the risk level (e.g., lowest risk level is prioritized over higher risk levels). In some embodiments such as described in more detail below, there may be multiple risk models 212 for the possible navigation route, where each risk model is applies to a sub-part (or ‘sub-route’) of the navigation route. In some cases, the risk model 212 may be built through machine learning on a multitude of data (e.g., from historical data from multiple training subjects with various characteristics and/or expert input). For example, expert input may indicate which risk factors are relevant to persons having certain characteristics and/or a machine-learning-based risk model 212 may be trained based on data (i.e., a ‘training data set’) showing the outcome of persons with certain characteristics when exposed to certain risk factors where the machine-learning model may be configured to identify patterns in the data and correlate certain characteristics with certain risk factors. As an example, the risk model 212 may implement a model in the form of a linear regression that can be expressed as the following:

$$r = {a}_{0} + {\sum }_{n = 1}^{N} {a}_{n} R {F}_{n}$$

where r is the risk value, RFₙ (n=1, . . . , N) are the values of relevant risk factors, and a₀ and aₙ (n=1, . . . , N) coefficients or weights that are obtained in the training process. For a user 202 to easily interpret the risk level, the risk model 212 may further stratify r into a number of intervals corresponding to e.g., low, medium or high level of risk. The choice on the type of model may be determined by whether r is numerical or categorical and the risk predication performance in the training.

The candidate navigation routes may be generated by a navigation application (e.g., as implemented by the user device 204 and/or navigation service 210). In some cases, the navigation application may evaluate the risk of each candidate navigation route and provide information ranking the navigation routes from lowest to highest risk. However, in case the navigation application misses a navigation route that has an even lower risk level (e.g., the lowest risk navigation route would not normally be contemplated since it is too long, for example), in some embodiments, the risk determination and navigation route identification may be implemented in conjunction with each other so that the navigation route planner may take into account the relevant risk factor(s) when identifying candidate navigation routes (which may also take into account other factors such as travel distance/time and transport options, etc.).

In some cases, the risk factor(s) may change over time, for example, during navigation. Therefore, the backend 304 may periodically (e.g., continuously or in response to any updates) obtain the latest information from remote data sources and the processing circuitry 310 may update its risk determination result from time to time. Based on the update, the recommended navigation route may change as well, and the navigation application may identify such an update for the user, request input from the user if the user would like to switch navigation route and/or automatically switch the navigation route for the user. Further embodiments are described below and may include certain features or functionality of the method 100, system 200 and/or architecture 300. Reference is made to the features and functionality described in relation to FIGS. 1 to 3 in the description of the following embodiments.

FIG. 4 refers to a method 400 of selecting a navigation route according to an embodiment. The method 400 is a computer-implemented method, which may be implemented by processing circuitry. The method 400 may be implemented in conjunction with and/or comprise the method 100. Thus, the method 400 may be implemented by a user device and/or a remote service such as provided in the cloud or provided by a server. Certain blocks of the method 400 may be omitted or implemented in a different order to that shown in accordance with certain embodiments described below.

The method 400 comprises, at block 402, receiving an indication of a first location and/or a second location. The first location corresponds to a present user location (e.g., as determined from a GNSS) and/or a departure location (e.g., as set by the user 202). The second location corresponds to a destination (e.g., as set by the user 202). The indication of the first and/or second location may be in a format (e.g., an address, GNSS co-ordinates, etc.) that can be interpreted by the navigation service 210.

The method 400 further comprises, at block 404, identifying the at least one candidate navigation route. The identified at least one candidate navigation route is between the first location and the second location. Block 404 may be implemented by the navigation service 210 and/or navigation route identification block 314.

The method 400 further comprises, at block 406, selecting, from the identified at least one candidate navigation route, a navigation route for the user based on at least one selection rule. Block 406 may be implemented by the navigation service 210 and/or navigation route identification block 314 in conjunction with the risk model 212 (e.g., as implemented by the risk determination block 312) and/or user input (e.g., via the frontend 302).

In some embodiments, the at least one selection rule specifies that the identified at least one candidate navigation route with the lowest risk level is to be selected for the user 202.

In some embodiments, the at least one selection rule specifies that the identified at least one candidate navigation route that has a risk level within the user's risk tolerance is to be selected. The user's risk tolerance may be determined based on the user's at least one characteristic (e.g., the risk tolerance may be based on a suggestion or assessment from a clinical professional based on the at least one characteristic) and/or the user's preference (e.g., a user may determine the user's risk tolerance or input information (e.g., the at least one characteristic and/or user preference) to allow processing circuitry 310 to determine the user's risk tolerance). If there is a plurality of identified candidate navigation routes, each having a risk level within the user's risk tolerance, one of the plurality of identified candidate navigation routes may be selected based on: which of the plurality of identified candidate navigation routes has the lowest travel time and/or distance; availability of transport options for each of the plurality of identified candidate navigation routes (e.g., if a certain transport option is unavailable for a certain selected navigation route, another transport option may be selected even if the associated navigation route is associated with a different level of risk over the previously selected navigation route); and/or the user's preference.

In some embodiments, the method 400 further comprises, at block 408, determining whether the risk level for the identified at least one candidate navigation route is within the user's risk tolerance. The user's risk tolerance is determined based on the user's at least one characteristic (e.g., the risk tolerance may be based on a suggestion or assessment from a clinical professional based on the at least one characteristic) and/or the user's preference. In some cases, the risk model 212 may determine a numerical or categorical risk level based on the at least one characteristic of the user and the at least one risk factor. Thus, for the same risk level associated with a candidate navigation route, the user's risk tolerance may be different depending on the user's at least one characteristic and/or preference. In an example, a user and/or a clinical professional may determine the user's risk tolerance or input information (e.g., the at least one characteristic and/or user preference) to allow processing circuitry 310 to determine the user's risk tolerance (e.g., which may be compared with the numerical or categorical risk level). For example, the user or clinical professional may be able to establish a threshold level of risk defining the user's risk tolerance (i.e., if the risk level determined by the risk model is above the threshold level of risk, then the identified at least one candidate navigation route may not be within the user's risk tolerance). This risk tolerance/threshold level of risk may refer to whether or not the health status of the user 202 may be at risk if the user 202 is subjected to the risk associated with the at least one geographical area. The risk tolerance may depend on the at least one characteristic associated with the user 202 and/or the user's preference (e.g., the user may have a different tolerance to risk according to their own personal decision).

Following block 408, the method 400 further comprises, at block 406, selecting the navigation route for the user that is with the user's risk tolerance based on the at least one selection rule.

In the embodiments described above in relation to the method 400, a candidate navigation route is selected for the user based on at least one selection rule (where it may be assumed that the selected navigation route is within the user's risk tolerance). However, in some cases, no suitable navigation route may be identified (e.g., there are no navigation routes within the user's risk tolerance).

Therefore, in some embodiments, if none of the identified at least one candidate navigation route have a risk level within the user's risk tolerance, the method 400 further comprises, at block 410, providing an indication that the identified at least one candidate navigation route is not within the user's risk tolerance. The indication may be displayed on the user interface 308 and/or may cause the processing circuitry 310 to attempt to identify an alternative navigation route.

In some embodiments, if none of the identified at least one candidate navigation route have a risk level within the user's risk tolerance, the method 400 further comprises, at block 406, selecting the navigation route for the user based on the at least one selection rule. In some embodiments, the at least one selection rule specifies that the identified at least one candidate navigation route with the lowest risk level is to be selected for the user. In some embodiments, the at least one selection rule specifies that the identified at least one candidate navigation route is to be selected based on: which of the identified at least one candidate navigation route has the lowest travel time and/or distance; availability of transport options for the identified at least one candidate navigation route; and/or the user's preference.

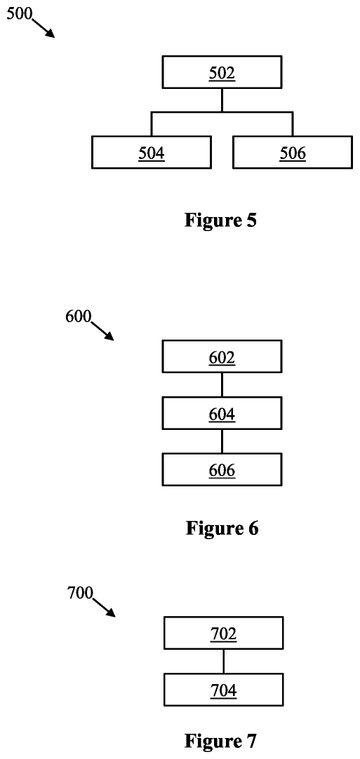

FIG. 5 refers to a method 500 of determining whether a risk level is within a user's risk tolerance according to an embodiment. The method 500 is a computer-implemented method, which may be implemented by processing circuitry. The method 500 may be implemented in conjunction with and/or comprise the method 400. Thus, the method 500 may be implemented by a user device and/or a remote service such as provided in the cloud or provided by a server. Certain blocks of the method 500 may be omitted or implemented in a different order to that shown in accordance with certain embodiments described below.

This embodiment may be implemented by or in conjunction with block 408 of the method 400. In other words, block 408 may implement the method 500.

The method 500 determines whether the risk level for the identified at least one candidate navigation route is within the user's risk tolerance by, at block 502, comparing the risk level for each of the identified at least one candidate navigation route with a risk tolerance metric indicative of the candidate navigation route being within the user's risk tolerance. The risk tolerance metric may refer to the threshold level or risk referred to above and may be represented by a number or risk level, as stratified by the risk model 212. In other words, the risk model 212 may stratify the risk levels for the user 202 and identify which of these risk levels corresponds to the risk tolerance metric and/or identify the user's risk tolerance based on the at least one characteristic.

In response to determining that the risk level for the candidate navigation route is within the user's risk tolerance, the method 500 further comprises, at block 504, identifying the candidate navigation route as being within the user's risk tolerance. In this case, any of the identified candidate navigation routes identified as being with the user's risk tolerance may be proposed as suitable navigation routes for the user. The at least one selection rule may specify which of the suitable navigation routes to select.

In response to determining that the risk level for the candidate navigation route is not within the user's risk tolerance, the method 500 further comprises indicating that the candidate navigation route is risky for the user. In this case, the user may be notified that the candidate navigation is not within their risk tolerance and/or a different candidate navigation route may be evaluated (e.g., at block 502) to identify an alternative, less risky, candidate navigation route. In the case that no suitable navigation routes are identified, the at least one selection rule may specify which of the candidate navigation routes to select (e.g., even if they are not within the user's risk tolerance).

FIG. 6 refers to a method 600 of selecting a navigation route according to user input according to an embodiment. The method 600 is a computer-implemented method, which may be implemented by processing circuitry. The method 600 may be implemented in conjunction with and/or comprise the method 400. Thus, the method 600 may be implemented by a user device and/or a remote service such as provided in the cloud or provided by a server. Certain blocks of the method 600 may be omitted or implemented in a different order to that shown in accordance with certain embodiments described below. This embodiment refers to embodiments where the user's preference is taken into account (e.g., as part of the at least one selection rule) when selecting the navigation route.

The method 600 comprises, at block 602, causing a graphical user interface (e.g., user interface 308) to display the identified at least one candidate navigation route alongside an indication of the risk level for each of the displayed candidate navigation routes. For example, each displayed candidate navigation route may be highlighted in a certain color indicative of risk and/or be shown with a label comprising text or an icon indicative of the risk level.

The method 600 further comprises, at block 604, receiving a user input indicative of the user's preference. For example, the user input may comprise selecting one of the displayed candidate navigation routes, an identification of a risk factor of particular concern to the user 202, a health status of the user 202 and/or any other information which may help to inform the determination of the risk level and/or the user's risk tolerance.

The method 600 further comprises, at block 606, selecting the navigation route for the user according to the user input.

FIG. 7 refers to a method 700 of generating and using navigation data according to an embodiment. The method 700 is a computer-implemented method, which may be implemented by processing circuitry. The method 700 may be implemented in conjunction with and/or comprise the method 400. Thus, the method 700 may be implemented by a user device and/or a remote service such as provided in the cloud or provided by a server. Certain blocks of the method 700 may be omitted or implemented in a different order to that shown in accordance with certain embodiments described below.

The method 700 comprises, at block 702, comprising generating navigation data corresponding to the selected navigation route. For example, the navigation service 210 and/or processing circuitry 310 may generate the navigation data.

In some embodiments, the navigation data may comprise the indication of the risk level referred to above.

In some embodiments, the method 700 further comprises, at block 704, causing a navigation application on a user device 204 to load the generated navigation data for use in providing navigation instructions for the user. For example, the frontend 302 of the architecture 300 may at least partially implement the navigation application on the user device 204 and the frontend 302 may receive the generated navigation data (e.g., from the backend 304).

Further embodiments relating to any of the methods 100, 400, 500, 600, 700 (and other embodiments) are described below.

In some embodiments, the user's at least one characteristic comprises information regarding at least one medical condition and/or demographic information associated with the user.

In some embodiments, the risk level for the at least one candidate navigation route is calculated using at least one risk model 212 configured to estimate the risk level for the user along the at least one candidate navigation route. The risk model 212 may be trained using a training data set indicative of at least one correlation between a plurality of risk factors and a plurality of characteristics. As described above, the risk model 212 may be trained using machine learning techniques. In other embodiments, the risk model 212 may be determined using non-machine-learning techniques. For example, the risk model 212 may be built or designed by a human such as an expert on correlations between risk factors and characteristics.

In some embodiments, the at least one risk model 212 is configured to estimate the risk level for the user along a plurality of sub-routes of the at least one candidate navigation route (e.g., there may be multiple risk models 212 where each risk model 212 applies to a sub-route of the at least one candidate navigation route). The risk level calculated for the at least one candidate navigation route may be based on a weighted combination of the estimated risk level associated with each of the plurality of sub-routes. For example, there may be different risks associated with each of the sub-routes making up a candidate navigation route. Another candidate navigation route may comprise at least one different sub-route with a different associated risk. Certain risks may be more relevant to the user 202 based on their at least one characteristic and/or preference. Thus, the risks associated with each sub-route may be weighted according to this relevance. Thus, certain navigation routes may have different risks but this may be taken into account to obtain an overall risk level for the whole navigation route so that the user 202 may be provided with the most appropriate navigation route according to their risk tolerance. In another scenario, there may be a plurality of navigation routes with similar overall risk levels but certain sub-routes may have different risks. Whichever route is selected, the user 202 may be subjected to the same or similar level of risk. In some cases, the user 202 may select which navigation route to use depending on their personal preference (e.g., if the overall risk level is the same, similar or within the risk tolerance).

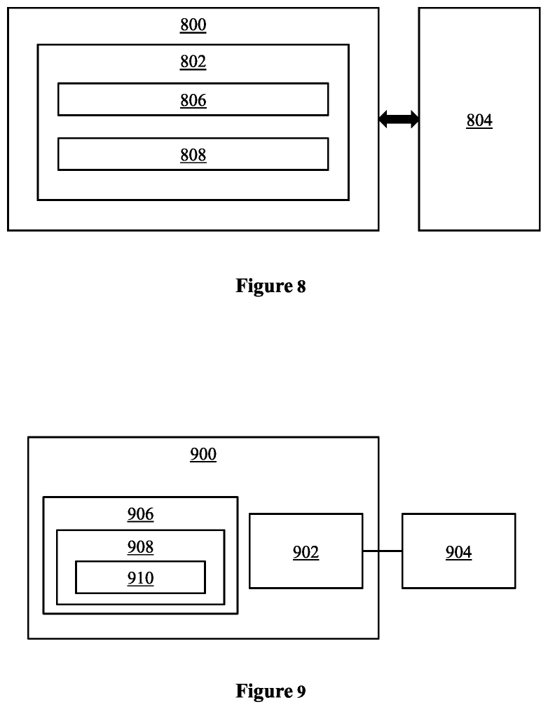

FIG. 8 shows a non-transitory machine-readable medium 800 for determining risk level in navigation according to an embodiment. The non-transitory machine-readable medium 800 comprises instructions 802 which, when executed by at least one processor 804 (e.g., corresponding to processing circuitry 310), cause the at least one processor 804 to implement certain methods described herein (e.g., methods 100, 400, 500, 600, 700 and/or any related embodiments). In this embodiment, the instructions 802 are configured to implement the method 100. The non-transitory machine-readable medium 800 may be implemented by any appropriate entity of FIG. 2 or 3 (e.g., a memory associated with the cloud 206, associated with the risk model 212, associated with the frontend 302 and/or associated with the backend 304). In addition, the at least one processor 804 may be provided by any appropriate entity of FIG. 2 or 3 (e.g., processing circuitry associated with the cloud 206, processing circuitry associated with the risk model 212 and/or processing circuitry associated with the front end 302 and/or backend 304). Thus, the system 200 and/or architecture 300 may be used for implementing the instructions 802 comprising the instructions described below.

The instructions 802 comprise instructions 806 for receiving an indication of at least one risk factor associated with at least one geographical area.

The instructions 802 comprise instructions 808 for determining a risk level for a user along at least one candidate navigation route comprising the at least one geographical area. The risk level is determined based on: the at least one risk factor; and at least one characteristic associated with the user.

In some embodiments, the instructions 802 comprise further instructions for implementing any of the other embodiments relating to the method 100 (e.g., methods 400, 500, 600, 700 and/or related embodiments).

FIG. 9 shows apparatus 900 for determining risk level in navigation according to an embodiment. The apparatus 900 comprises at least one processor 902 (e.g., implemented by processing circuitry associated with the cloud 206, processing circuitry associated with the risk model 212 and/or processing circuitry associated with the front end 302 and/or backend 304). The at least one processor 902 is communicatively coupled to an interface 904 for communicating data (e.g., data to/from the frontend 302 and/or backend 304 and/or between certain entities shown in FIGS. 2 and 3). In this embodiment, the interface 904 is configured to receive an indication of at least one risk factor associated with at least one geographical area (e.g., in accordance with block 102 of the method 100). For example, the interface 904 may be communicatively coupled to the risk identification service 208 referred to in FIG. 2.

The apparatus 900 further comprises a non-transitory machine-readable medium 906 storing instructions 908 readable and executable by the at least one processor 902 to perform a method corresponding to certain embodiments described herein (e.g., any of the methods 100, 400, 500, 600, 700 and/or related embodiments).

In this embodiment, the instructions 908 comprise instructions 910 to cause the at least one processor 902 to determine a risk level for a user along at least one candidate navigation route comprising the at least one geographical area (e.g., in accordance with block 104 of the method 100). The risk level is determined based on: the at least one risk factor; and at least one characteristic associated with the user.

In some embodiments, the instructions 908 comprise further instructions for implementing any of the other embodiments relating to the method 100 (e.g., methods 400, 500, 600, 700 and/or related embodiments).

While the invention has been illustrated and described in detail in the drawings and foregoing description, such illustration and description are to be considered illustrative or exemplary and not restrictive; the invention is not limited to the disclosed embodiments.

One or more features described in one embodiment may be combined with or replace features described in another embodiment.

Embodiments in the present disclosure can be provided as methods, systems or as a combination of machine-readable instructions and processing circuitry. Such machine-readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices, and systems according to embodiments of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general-purpose computer, a special purpose computer, an embedded processor, or processors of other programmable data processing devices to realize the functions described in the description and diagrams. In particular, a processor or processing circuitry, or a module thereof, may execute the machine-readable instructions. Thus, functional modules of apparatus and other devices described herein may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the embodiments of the present disclosure.

Elements or steps described in relation to one embodiment may be combined with or replaced by elements or steps described in relation to another embodiment. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computer-implemented method, comprising:
receiving an indication of at least one risk factor associated with at least one geographical area; and
determining a risk level for a user along at least one candidate navigation route comprising the at least one geographical area, wherein the risk level is determined based on:
the at least one risk factor; and
at least one characteristic associated with the user.

2. The method of claim 1, comprising:
receiving an indication of a first location and/or a second location, wherein the first location corresponds to a present user location and/or a departure location, and wherein the second location corresponds to a destination;
identifying the at least one candidate navigation route, wherein the identified at least one candidate navigation route is between the first location and the second location; and
selecting, from the identified at least one candidate navigation route, a navigation route for the user based on at least one selection rule.

3. The method of claim 2, comprising:
determining whether the risk level for the identified at least one candidate navigation route is within the user's risk tolerance, wherein the user's risk tolerance is determined based on the user's at least one characteristic and/or the user's preference; and
selecting the navigation route for the user that is with the user's risk tolerance based on the at least one selection rule.

4. The method of claim 3, comprising determining whether the risk level for the identified at least one candidate navigation route is within the user's risk tolerance by:
comparing the risk level for each of the identified at least one candidate navigation route with a risk tolerance metric indicative of the candidate navigation route being within the user's risk tolerance; and
in response to determining that the risk level for the candidate navigation route is within the user's risk tolerance, identifying the candidate navigation route as being within the user's risk tolerance; or
in response to determining that the risk level for the candidate navigation route is not within the user's risk tolerance, indicating that the candidate navigation route is risky for the user.

5. The method of claim 2, wherein the at least one selection rule specifies that:
the identified at least one candidate navigation route with the lowest risk level is to be selected for the user; and/or
the identified at least one candidate navigation route that has a risk level within the user's risk tolerance is to be selected, wherein the user's risk tolerance is determined based on the user's at least one characteristic and/or the user's preference, and wherein if there is a plurality of identified candidate navigation routes each having a risk level within the user's risk tolerance, one of the plurality of identified candidate navigation routes is to be selected based on: which of the plurality of identified candidate navigation routes has the lowest travel time and/or distance; availability of transport options for each of the plurality of identified candidate navigation routes; and/or the user's preference.

6. The method of claim 2, wherein, if none of the identified at least one candidate navigation route have a risk level within the user's risk tolerance, wherein the user's risk tolerance is determined based on the user's at least one characteristic and/or the user's preference, the method comprises:
providing an indication that the identified at least one candidate navigation route is not within the user's risk tolerance; and/or
selecting the navigation route for the user based on the at least one selection rule, wherein the at least one selection rule specifies that:
the identified at least one candidate navigation route with the lowest risk level is to be selected for the user; and/or
the identified at least one candidate navigation route is to be selected based on: which of the identified at least one candidate navigation route has the lowest travel time and/or distance; availability of transport options for the identified at least one candidate navigation route; and/or the user's preference.

7. The method of claim 2, comprising:
causing a graphical user interface to display the identified at least one candidate navigation route alongside an indication of the risk level for each of the displayed candidate navigation routes;
receiving a user input indicative of the user's preference; and
selecting the navigation route for the user according to the user input.

8. The method of claim 2, comprising generating navigation data corresponding to the selected navigation route.

9. The method of claim 8, comprising causing a navigation application on a user device to load the generated navigation data for use in providing navigation instructions for the user.

10. The method of claim 1, wherein the user's at least one characteristic comprises information regarding at least one medical condition and/or demographic information associated with the user.

11. The method of claim 1, wherein the risk level for the at least one candidate navigation route is calculated using at least one risk model configured to estimate the risk level for the user along the at least one candidate navigation route, wherein the risk model is trained using a training data set indicative of at least one correlation between a plurality of risk factors and a plurality of characteristics.

12. The method of claim 11, wherein the at least one risk model is configured to estimate the risk level for the user along a plurality of sub-routes of the at least one candidate navigation route, and wherein the risk level calculated for the at least one candidate navigation route is based on a weighted combination of the estimated risk level associated with each of the plurality of sub-routes.

13. The method of claim 1, wherein the at least one risk factor comprises an environmental risk and/or presence of at least one infectious agent within the at least one geographical area.

14. A non-transitory machine-readable medium storing instructions readable and executable by at least one processor to cause the at least one processor to implement the method of claim 1.

15. Apparatus comprising:
at least one processor communicatively coupled to an interface for receiving an indication of at least one risk factor associated with at least one geographical area; and
a non-transitory machine-readable medium storing instructions readable and executable by the at least one processor to cause the at least one processor to:
determine a risk level for a user along at least one candidate navigation route comprising the at least one geographical area, wherein the risk level is determined based on:
the at least one risk factor; and
at least one characteristic associated with the user.
